(19) United States
(12) Patent Application Publication
(10) Pub. No.: US 2002/0124808 A1
(43) Pub. Date: Sep. 12, 2002

(54) Carrier for pets

(76) Inventors: Deann Zampelli, Los Angeles, CA (US); DeEdyre J. Burks, Los Angeles, CA (US)

Correspondence Address: COLIN P ABRAHAMS, 5850 CANOGA AVENUE, SUITE 400, WOODLAND HILLS, CA, 91367

(21) Appl. No.: 09/799,948

(22) Filed: Mar. 6, 2001

(51) Int. Cl. A01K 7/00; A01K 1/00; A45C 3/00; A45F 3/04; A01K 1/03

(52) U.S. Cl. 119/497; 119/72; 224/643; 190/112

(57) ABSTRACT

A pet carrier comprises a container having side walls, a base and a top portion defining a space for receiving a pet. The container has at least one handle attached to it for carrying the container. An adjustable opening is provided in the container, and a padded material is formed along at least a portion of the edge of the opening. A pliable strip is provided in the opening to regulate the size and shape of the adjustable opening. Water dispensing may provided in or on the pet carrier.

### BACKGROUND OF THE INVENTION

This invention relates to a carrier for pets, and particularly, although not limited to, a carrier for domestic pets, such as small dogs and cats.

Particularly, the invention relates to portable and fashionable luggage type carriers comprising a container for the pet, and straps or handles to enable the owner of the pet to easily hold the carrier by the hands, on the back in backpack style, over the shoulder, or in any other convenient manner.

Many types of conveyers for pets are known, and there are numerous examples in the prior art showing different types of carriers. One example of prior art pet carrier is shown in U.S. Pat. No. 5,176,102 (Tracy) which describes a pet carrier worn about the human torso and which has an open top through which the head of the pet projects.

U.S. Pat. No. 3,850,144 (Springer) teaches a carrying bag where the head and neck extend through an opening in the end of the bag, the size of which opening is controlled by an adjustable fastening means so that the animal will be restrained within the bag without discomfort.

U.S. Pat. No. 4,977,857 (Slawinskl) shows a pet carrier bag including a flexible body with a slit along the upper surface. A cut-out portion is provided at one end so that a small animal can be contained within the flexible body. The head of the animal extends through the cut-out portion when the bag is otherwise closed. A meshed snout portion retains the pet within the carrier.

U.S. Pat. No. 5,419,281 (Williams) shows a backpack style carrier which is mounted on a frame, and a circular collar is provided through which the head and neck of the animal is received. Straps enable adjustment of a circular flap so that variations according to the size of the animal can be made.

U.S. Design Pat. No. 290,176 (Demeuse) illustrates a pet carrier which apparently includes a cushioned opening. International Application No. PCT/US96/04700 shows a backpack style animal carrier and restraint including a frame. The enclosure includes an upstanding wall and an opened top end.

As will be noted form the examples of patents relating to pet carriers described above, there are many different forms and configurations of pet carriers which are constructed for specific purposes and have particular application.

In the present invention, a pet carrier having defined features and elements is described which enhance and contribute towards the safety and comfort of the pet being conveyed.

### SUMMARY OF THE INVENTION

In one aspect, the pet carrier of the invention comprises a container defining a space in which the animal is placed. The container has fixed thereto various straps or handles which facilitate its transportation, and these may include back straps to carry the container backpack style, handles for holding the container by hand, and a sling strap which may facilitate carrying the container over the shoulder. Preferably, the pet carrier of the invention includes a closable cover, which may serve the purpose of disguising the pet from the public eye. It may further comprise an opening for the head of the animal, which has a cushioned rim or periphery to provide a soft surface in order to provide additional comfort to the animal or even to protect the animal against injury by which may result sudden movement. The opening may include a cover which is adjustable, so that the size of the opening can be varied according to the size of the animal, and which may also enable the pet to be concealed from public view. Preferably, a drawstring, which preferably includes a safety toggle, is located in the cover about the opening, so that adjustment thereof can be made by varying the position of the drawstring to enlarge or reduce the size of the opening.

In a preferred form, the cover also includes a pliable or malleable metal, plastic or other type of strip which can be bent or shaped to keep the cover open, and define a variable size window in the cover. The advantage of the pliable strip is that the opening can be shaped and located according to the user's preference, in such a way that the opening will remain in the form in which it has been created until further adjustment.

According to one aspect of the invention, there is provided a pet carrier comprising a container having side walls, a base and a top portion defining a space for receiving a pet; at least one handle attached to the container for carrying the container; an adjustable opening in the container, the adjustable opening having a padded interior along at least a portion of an edge thereof; and means for regulating the size and shape of the adjustable opening.

Preferably, at least a portion of one side wall is comprised of a mesh material to provide ventilation to the container as well as viewing capability for the animal inside the container. The mesh material is conveniently provided on opposing sidewalls of the container. The base may comprise absorbent material, and/or a cushioning member, which may be removable.

Preferably, the adjustable opening is padded along substantially all of its edges. The adjustable opening may include a flap member in or at the top portion, the flap member having a seamed edge, and a drawstring at least partially located within the seamed edge and having ends protruding from the seamed edge, the ends of the drawstring being adjustable to bunch the flap in different positions so as to vary the size of the adjustable opening. The seamed edge may also contain a pliable strip therein which can be bent and shaped so as to determine and maintain the adjustable opening in a desired position.

Attachment means, which may be in the form of a hook with an elasticized cord, at or near the adjustable opening may be provided, the attachment means for fastening to a collar of a pet when in the container.

According to another aspect of the invention, there is provided a pet carrier comprising a container having side walls, a base and a top portion defining a space for receiving a pet; at least one handle attached to the container for carrying the container; an opening in the container through which a pet may be inserted and removed; and a water dispensing pocket for releasably holding a water dispenser to which the pet has access.

Other features of the pet carrier may include double-zippered or double snap closure means, useful to protect animals with longer hair, and a closable cover which can be stored when in the open position, preferably in a hidden pocket so that it will be out of view and in a protected enclosure while not in use.

### BRIEF DESCRIPTION OF THE DRAWINGS

FIG. 1 is a perspective view of a first embodiment of the pet carrier of the invention;

FIG. 2 is perspective view of a second embodiment of the pet carrier of the invention;

FIG. 3 is a perspective view of a third embodiment of the pet carrier of the invention;

FIG. 4 is a perspective view of a fourth embodiment of a pet carrier of the invention; and

FIG. 5 is a perspective view of a fifth embodiment of a pet carrier of the invention, including a water bottle.

### DETAILED DESCRIPTION OF THE PREFERRED EMBODIMENTS

In the various figures illustrated and described herein, different embodiments of pet carriers are shown, although several features are common to all. Each embodiment may, however, be designed to suit a particular situation, so that a more customized pet carrier can be provided. For example, the dimensions and location of certain features may be varied according to the size of the dog.

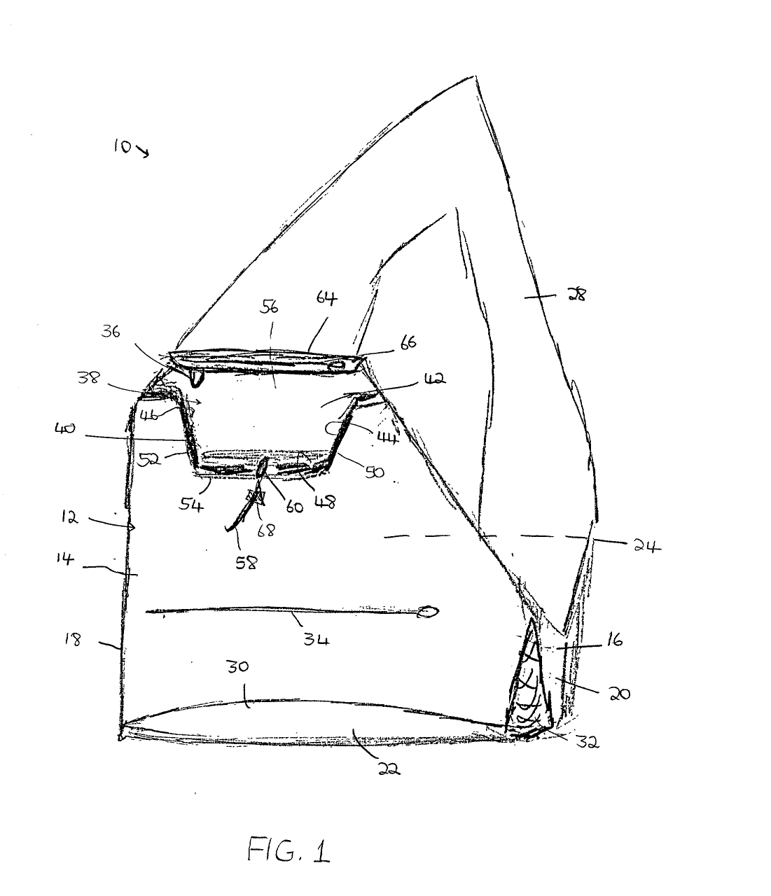

Reference is now made to FIG. 1 of the drawings, which shows a standard embodiment of the invention. In FIG. 1, there is shown a pet carrier 10 including a container 12 comprised of side walls 14 and 16, end walls 18 and 20, and a base 22. The various walls and base define an interior space 24 which accommodates the animal, usually a small dog or cat. The container 12 has attached thereto a cushioned strap 28 by means of which the pet carrier can be either held in the hand, or slung over the shoulder. Further, the base 22 includes, or has mounted thereon, a cushioned member 30, and the base 22 and cushion member 30 in combination provide a flat, substantially non-bendable floor on which the animal is supported. The base 22 and cushion member 30 arrangement may also, optionally, comprise absorbent material, which may be disposable and easily changeable as necessary.

The end wall 20 includes a mesh window 32 to facilitate ventilation of the space 24, as well as to provide a viewing capability to the animal inside carrier 10. Further, the side wall 14 includes a pocket, access to which is obtained through zipper 34 which can be opened and closed in a conventional manner to seal and protect any of the contents in the pocket.

As a further accessory for the convenience of the user, a loop 36 may be provided to form the basis and support for a hook, thereby permitting certain accessories to be hooked onto the pet carrier 10 without having to be separately carried by the user.

The container 12 is generally closed off at its top end by cover 38, which can be opened and closed as will be described below, in order to access the space 24 and insert and remove the animal. An important feature of the invention is the provision of a padded edge 40 at the edge of or along a substantial part of the perimeter of the cover 38. The padded edge 40 is designed and incorporated into the cover 38 of the pet carrier in such a manner that it is located at the edges, and represents that portion of the carrier at which the head or neck of the pet will be located. Any sudden movement of the pet carrier 10 which may cause the pet to lose balance will, as a result, be less harmful or injurious to the animal since the padded edge 40 will provide a cushioned and a soft rounded edge to cushion the impact.

The padded edge 40 may be comprised of a faux fur strip lined along the edge, or may be a cotton or sponge padded insert hemmed at the edge of the cover 38. These are just certain examples of the type of padded edge that may be incorporated, although many other types of padding form part of this invention.

The cover 38 comprises a flap 42 having side edges 44 and 46, and end edge 48. The side wall 14 of the container 13 has substantially corresponding side edges 50 and 52, and end edge 54.

The flap 42 and side wall 14 are shaped such that side edges 44 and 50, side edges 46 and 52, and end edges 48 and 54 respectively lie alongside each other when the flap 42 is in the closed position. It will be appreciated that the padded edges 40, may be located along all of these side and end edges, or along selected edges only.

The flap 42 may be opened or closed, thereby creating an opening 56 through which the head or head and neck of the animal may project. The size of the opening can further be controlled as desired. In this regard, a drawstring 58 is located in a hem along side edges 44 and 46 and end edge 48. The hem includes an hole 60 through which the drawstrings protrude. Pulling the drawstring 58 through the hole 60 “bunches” the side edges 44 and 46 as well as the end edge 48, thereby creating an opening between the side and end edges of the flap, and the side and end edges of the side wall 14. A drawstring catch 62 can be positioned about the drawstring 58 outside the opening 60 to fix the drawstring 58 in a desired position, and to keep the opening of the desired dimensions. Varying the position and tightness of the drawstring 58 will determine the size of the opening 56 which can thus be customized to suit the particular pet.

If it is desired to keep the animal completely within the space 24, the flap 42 can be closed. The flap 42 can be releasably secured with respect to the side wall 14 by providing a fastening mechanism, such as zippers or Velcro™ material, along the edges.

The pet carrier shown in FIG. 1 also includes a receptacle 64, sealed by zipper or Velcro™ closure 66. The receptacle 64 contains a hood (not shown) which can be removed from the receptacle 64 to provide additional covering or protection for the animal. Preferably, the hood is fastened along an edge thereof within the receptacle 64 so that it cannot come loose and get lost.

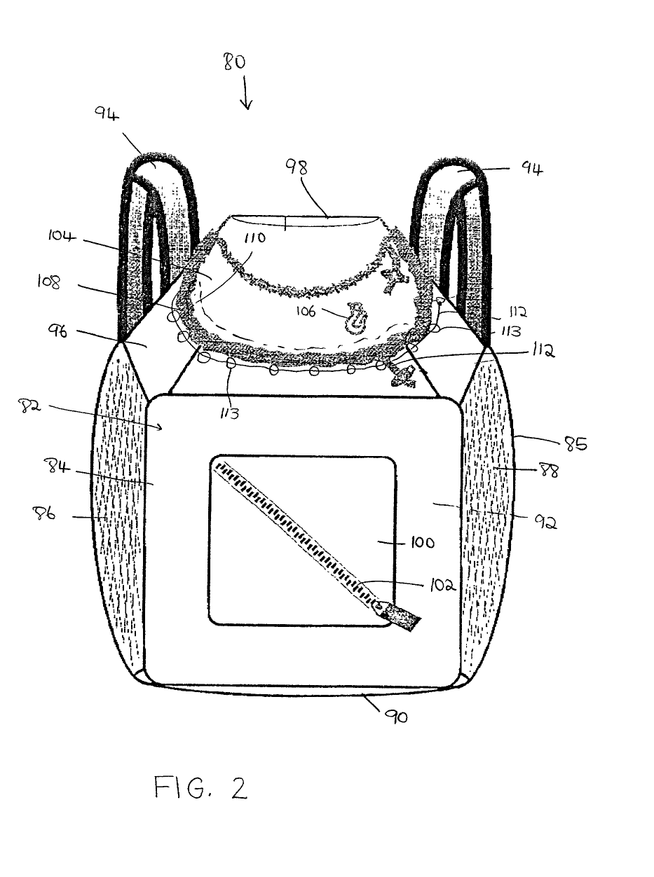

Reference is now made to FIG. 2 of the drawings, which shows a pet carrier 80 comprising a container 82 including a front wall 84, back wall 85, side walls 86 and 88, a base wall 90, all of which define a space 92 in which the animal is contained. The base wall 90 may include a cushioned, removable member, absorbent material, fragrances, or other components, several of which have been described with reference to FIG. 1 and will not be illustrated specifically in this embodiment.

The pet carrier 80 shown in FIG. 2 is particularly useful for transportation, and to this end, includes a pair of backpack straps 94, preferably padded, which are attached to the padded back wall 85 of the container 82. The pet carrier 80 comprises a top cover 96 which extends and tapers upwardly from the front wall 84, back wall 85 and the two side walls 86 and 88. The top cover 96 terminates in an upper end 98, in which may be contained a hidden hood for removal and replacement as needed. The hidden hood is preferably attached along a portion thereof within the receptacle, and has a similar function and structure to that briefly described with respect to FIG. 1.

Each side wall 86 and 88 of the container 82 may be comprised either partially or completely of a mesh material to ensure adequate ventilation of the space 92. Further, an outside pocket 100 is provided on the front wall 84, and access to the pocket is obtained by opening and closing the zipper 102.

The top cover 96 incorporates a variable sized flap 104 which can be opened and closed as will be described, to insert and remove the pet. Moreover, the flap 104 can be adjusted so that an opening of variable size can be created and maintained to suit the particular animal, as well as the circumstances under which it is being transported.

Inside the opening, at about the position of the flap 104, there may be located an elasticized cord and hook 106 which can be releasably attached to a collar of the animal, and this has the effect of stabilizing the animal within the space 92. In the case of a sudden movement, the collar of the animal hooked onto the loop 106 would safely limit the amount of movement of the animal and help to keep it steady.

The flap 104 can be fastened or attached to the top cover 96 by a zipper, Velcro™ or other material. Inside the pet carrier 80, there may be a pocket, preferably having a Velcro™ sealing arrangement, which may receive the folded flap 104, where it can be stored until needed. The periphery 108 of the flap 104 incorporates a strip of padded material 110 for the comfort of the animal, and a drawstring 112 is contained in a hem or a series of eyelets 113, also along the periphery 108 of the flap 104. The padded material may be cushioned with, for example, faux fur. By pulling in, or releasing, the drawstring 112, the flap 104 can be either “bunched” or fully extended, and the position of the drawstring 112 will therefore determine the size, if any, of the opening provided by the adjustment of the flap 104.

Also located within and along the periphery 108 of the flap 104 is a pliable strip 110 which has properties which enable it to be bent into any desired shape, and to hold that shape. The pliable strip 110 thus acts to complement the function of the drawstring 112. While the drawstring 112 is useful in regulating the size of any opening in the flap 104, the pliable strip 110 can be used to regulate the shape and position of the opening according to the circumstances.

The pet carrier 80 may also have a small loop of weighted metal at the end of the flap 104 which may attach to a sewn piece of material on the carrier which is looped through the metal for closure.

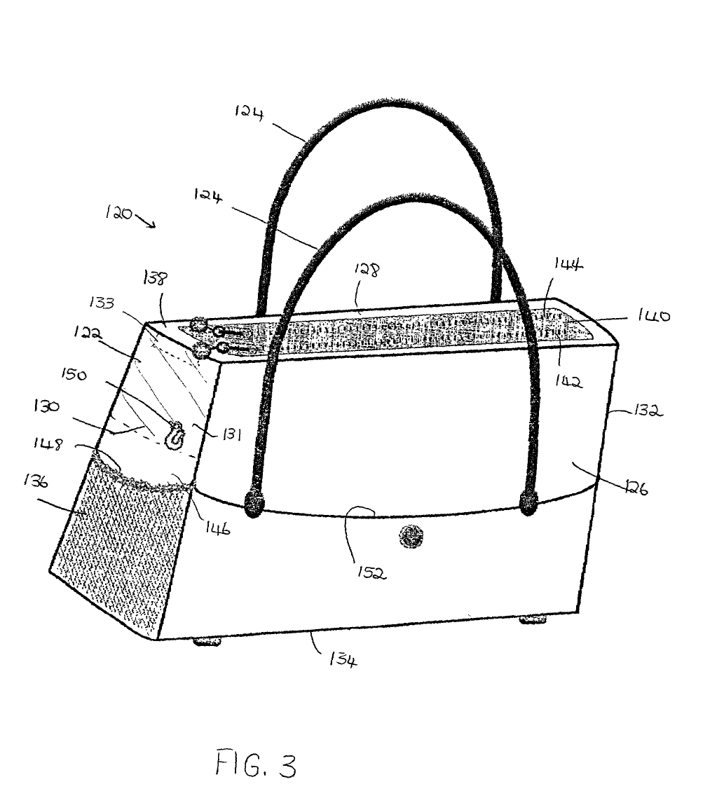

FIG. 3 of the drawings shows a pet carrier 120 in the configuration of a designer tote bag, and comprises a container 122 and a pair of hand straps 124. The container 122 has side walls 126 and 128, end walls 130 and 132, and a base wall 134. The end walls 130 and 132, or only one of them, may have a mesh panel 136 for ventilation purposes. The container 122 further has a top wall 138 including an opening flap 140 which has a pair of zippers 142 and 144 which can be opened and closed to place the animal in, or remove the animal from, the container 122, while shielding the animal's hair from getting caught in the zipper. The container 122 also comprises a retractable opening 131 which can be rolled down to permit the animal's head to come out, and includes a closure 133 on the inside of the container 122 to close the opening 131. The closure may be Velcro™. The top closure could also be comprised of a single flap which is secured by a snap closure.

The end wall 130 includes an opening 146 which has a padded edge 148, and a hook 150 is provided to attach to the collar of the animal, as has been described above.

FIG. 3 also illustrates the presence of side pockets 152 with snap closures.

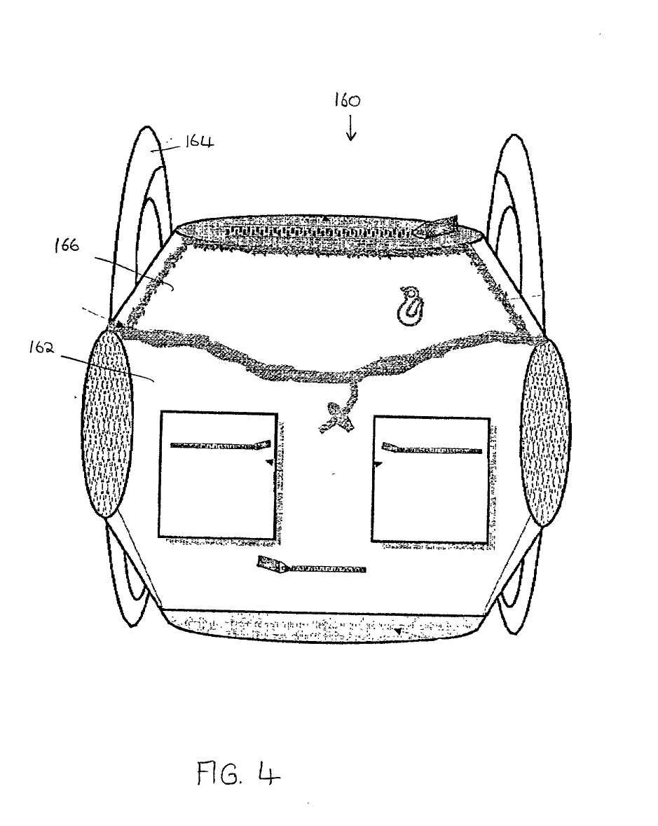

FIG. 4 of the drawings shows yet a further embodiment, including a pet carrier 160 comprising a container 162 and straps 164 for carrying the container. The embodiment shown in FIG. 4 is very similar to that shown in FIG. 2, but the side walls are of a slightly different shape, and the pet carrier 160 additional pockets and compartments for storage of loose items. Importantly, the pet carrier 160 includes the flap 166, including a drawstring, pliable strip, and other similar features described with reference to FIG. 2, which enable not only the size of the opening to be regulated, but also its particular shape and position with respect to the pet carrier 160 as a whole, thereby providing the pet carrier 160 with considerable flexibility to accommodate animals of different sizes, and in different conditions.

As will be noted from the figures, the flap 104 includes the padded material 110. Furthermore, the top cover 96, from which the flap 104 may be lifted and separated along at least a part of their common edges, also has padded material so that, when the head and neck of the animal project outwardly from the opening all edges will have the necessary padding to protect the animal and provide for its comfort.

The flap 104 has an edge, shown partially in section, defining a seam which is constructed so as to form an elongate channel along the edge of the flap 104. Contained within the channel is the drawstring 112, which also extends through a hole 60 so that the particular size of the opening, as determined by the position of the drawstring 112, can be adjusted. Also within the channel is the pliable strip 110 which is constructed of a material which allows is to be somewhat easily bent without breaking, and to retain its position until moved again.

It will be noted that the combination of the drawstring 112 and the pliable strip 110 permit the size of the opening to be adjusted, and its position to be maintained. Thus, the drawstring is adjusted to determine the size of the opening, and, thereafter, the pliable strip is bent into a position so that the opening is actually in the position desired.

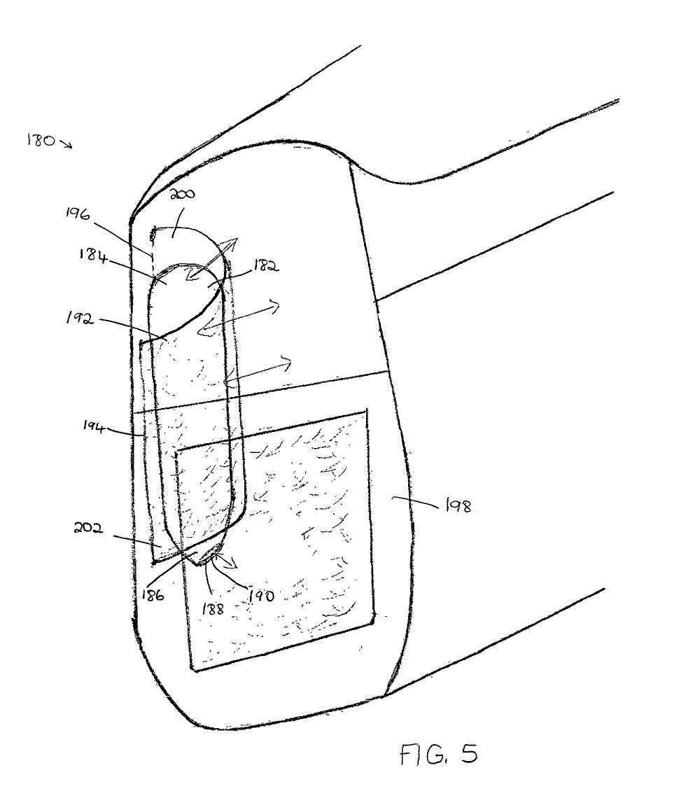

FIG. 5 of the drawings shows a pet carrier 180 including the feature of a water dispenser 182 for use by an animal accommodated in the carrier 180. The water dispenser 182 is of cylindrical shape and has a closed base end 184 and a top end 186 which incorporates a spout 188, preferably of the roller or ball type. The roller ball 190 is located in the spout 188 in conventional fashion so that it operates as a valve under pressure from the water to keep the spout 186 closed. When the roller ball 190 is forced back from the spout 188 by the animal's nose or other body part, the valve is opened and water is permitted to slowly pass through the spout 188 for the animal's access. As soon as the animal is no longer pressing the ball 190, it will close the spout 188 and seal off the water supply. Therefore, there will be little or no leakage of water into the carrier 180.

The water dispenser 182, preferably made of plastic material, is held within a pocket 192 within the carrier 180 in a substantially vertical inverted position. The pocket 192 comprises a piece of material stitched at its sides 194 and 196 to an end portion 198 of the carrier 180. The pocket 192 defines a channel in which the water dispenser 182 can be easily removed and inserted by simply sliding it in or out through the open top end 200. When so inserted, the spout 188 and ball 190 project through the open lower end 202 defined by the pocket 192, thereby providing the animal with access to the water. The pocket 192 may be of a material which is meshed, and may also be stretchable for more effective holding of the water dispenser 182 in the pocket 192.

The size of the pocket 192 can be varied depending on the size of the water dispenser 182 to be held. This will, of course, take into account the size and type of the animal. Further, the space defined by the pocket 192 may be accessible from the outside of the carrier 180 by a closable opening or the like, to make it easier to remove and replace the dispenser 182. Further, the pocket itself may be outside the carrier 180, with an opening in the wall of the carrier 180 through which the spout and ball valve can be located so as to extend inside the carrier. The pocket 192 itself may be releasably connected to the carrier for removal, and the connection may be achieved by using Velcro, clamps, snaps or the like.

The invention is not limited to the precise details disclosed and illustrated herein.

1. A pet carrier comprising:
a container having side walls, a base and a top portion defining a space for receiving a pet;
at least one handle attached to the container for carrying the container;
an adjustable opening in the container, the adjustable opening having a padded interior along at least a portion of an edge thereof; and
means for regulating the size and shape of the adjustable opening.

2. A pet carrier as claimed in claim 1 wherein at least a portion of one side wall is comprised of a mesh material to provide ventilation to the container.

3. A pet carrier as claimed in claim 2 wherein the mesh material is provided on opposing sidewalls of the container.

4. A pet carrier as claimed in claim 1 wherein the base comprises absorbent material.

5. A pet carrier as claimed in claim 1 wherein the base comprises a cushioning member.

6. A pet carrier as claimed in claim 1 wherein the handle comprises a pair of straps to enable the pet carrier to be mounted on the back of a user.

7. A pet carrier as claimed in claim 1 wherein the handle is padded to provide additional comfort to the user.

8. A pet carrier as claimed in claim 1 wherein the handle comprises a shoulder sling member.

9. A pet carrier as claimed in claim 1 further comprising at least one pocket member on the outside of the container.

10. A pet carrier as claimed in claim 1 wherein the adjustable opening is padded along substantially all of its edges.

11. A pet carrier as claimed in claim 1 wherein the adjustable opening includes a flap member in or at the top portion, the flap member having a seamed edge, and a drawstring at least partially located within the seamed edge and having ends protruding from the seamed edge, the ends of the drawstring being adjustable to bunch the flap in different positions so as to vary the size of the adjustable opening.

12. A pet carrier as claimed in claim 1 wherein the adjustable opening includes a flap member having a seamed edge, the seamed edge containing a pliable strip therein which can be bent and shaped so as to determine and maintain the adjustable opening in a desired position.

13. A pet carrier as claimed in claim 1 further comprising a hood member which can be placed over the adjustable opening.

14. A pet carrier as claimed in claim 13 further comprising a sealable pocket, the sealable pocket accommodating the hood when in a closed or non-use position.

15. A pet carrier as claimed in claim 1 further comprising attachment means at or near the adjustable opening, the attachment means for fastening to a collar of a pet when in the container.

16. A pet carrier as claimed in claim 1 further comprising an access opening in the top portion of the container, the access opening having a pair of spaced zippers thereon.

17. A pet carrier as claimed in claim 16 wherein the access opening is located on the adjustable opening.

18. A pet carrier comprising:
a container having side walls, a base and a top portion defining a space for receiving a pet;
at least one handle attached to the container for carrying the container;
an opening in the container through which a pet may be inserted and removed; and
a water dispensing pocket for releasably holding a water dispenser to which the pet has access.

19. A pet carrier as claimed in claim 18 wherein the water dispensing pocket comprises a strip of material having side edges which are stitched to one of the side walls on the inside of the pet carrier, the strip of material defining a space for securely holding the water dispenser.

20. A pet carrier as claimed in claim 19 further comprising a water dispenser located in the water dispensing pocket.

21. A pet carrier as claimed in claim 20 wherein the water dispenser comprises a substantially cylindrical plastic tube mounted in an inverted position in the water dispensing pocket, the plastic tube having a roller ball valve spout near its lower end for controlling the flow of water from the water dispenser.

22. A pet carrier as claimed in claim 18 wherein the water dispensing pocket is located on a side wall on the outside of the pet carrier, the pet carrier further comprising an aperture through which a pet in the carrier accesses the water dispenser.
